(19) United States
(12) Patent Application Publication
(10) Pub. No.: US 2025/0011516 A1
(43) Pub. Date: Jan. 9, 2025

(54) Method for Preparing Polymers

(71) Applicant: LANXESS Deutschland GmbH, Cologne (DE)

(72) Inventor: Julian Krischel, Cologne (DE)

(73) Assignee: LANXESS Deutschland GmbH, Cologne (DE)

(21) Appl. No.: 18/708,868

(22) PCT Filed: Nov. 15, 2022
(86) PCT No.: PCT/EP2022/081892

§ 371 Date: May 9, 2024

(30) Foreign Application Priority Data
Nov. 18, 2021 (EP) 21208890.0

(51) Int. Cl. C08F 236/10; C08K 5/10; C08K 5/14

(52) U.S. Cl. CPC C08F 236/10; C08K 5/10; C08K 5/14

(57) ABSTRACT

The invention relates to the preparation of a polymer in the presence of a dispersant mixture and to the use thereof for preparing the polymer in order to produce ion exchangers therefrom.

The invention relates to the preparation of a polymer in the presence of a dispersant mixture and to the use thereof for preparing the polymer in order to produce ion exchangers therefrom.

It is known that polymers can be prepared from for example vinylaromatic compounds, such as styrene, together with crosslinking agents, such as divinylbenzene, by means of suspension polymerization.

In suspension polymerization, a monomer phase containing an initiator that is soluble in the monomer is divided in the form of droplets in a phase which is essentially immiscible with the monomer, and cured by increasing the temperature. The immiscible phase is usually an aqueous phase that may contain additives, such as salts, dispersants or protective colloids or other water-soluble organic compounds and is also referred to as continuous phase. A mixture of selected, water-insoluble monomers and additives and initiators dissolved therein then forms the dispersed phase.

In addition to gel-form polymers, macroporous polymers can also be produced in suspension polymerization by using porogens, such as high-boiling aliphatic hydrocarbons, alcohols, ethers, nitro compounds or esters.

It is known from F. Jahanzad, S. Sajjadi, B. Brooks, Polymer 2013, 54, 16-23, that during a suspension polymerization of methyl methacrylate there is also simultaneously to some degree occurrence of emulsion polymerization and hence also formation of undesired polymeric fines fraction. The polymeric fines fraction formed by the emulsion polymerization can be reduced by the addition of a free-radical inhibitor that is soluble in the aqueous phase.

EP-A-0964002 discloses a process for preparing gel-form bead polymers having a decreased content of soluble polymers. In order to reduce the soluble fraction, a peroxyester is used as an initiator in this process.

In view of the known prior art, there still remains a need for a process with which the polymeric fines fraction can be reduced when preparing macroporous polymers.

It has now been found, surprisingly, that the polymeric fines fraction can be decreased if a specific dispersant mixture is used during the polymerization.

The invention therefore provides a process for preparing a polymer, in which at least one monoethylenically unsaturated compound and at least one multiethylenically unsaturated compound are reacted in the presence of at least one initiator, in the presence of water, in the presence of a porogen and in the presence of a dispersant mixture comprising
a) at least one hydroxyalkylmethylcellulose having a number-average molecular weight of 80 000 g/mol to 110 000 g/mol and
b) at least one hydroxyalkylmethylcellulose having a number-average molecular weight of 25 000 g/mol to 42 000 g/mol.

The term “molecular weight” refers in the application to the number-average molecular weight unless explicitly stated or specified otherwise.

Preference is given to using, as hydroxyalkylmethylcelluloses under a.), hydroxypropylmethylcellulose and/or hydroxyethylmethylcellulose having a molecular weight of 80 000 g/mol to 110 000 g/mol.

Preference is given to using, as hydroxyalkylmethylcelluloses under b.), hydroxypropylmethylcellulose and/or hydroxyethylmethylcellulose having a molecular weight of 25 000 g/mol to 42 000 g/mol.

Preference is given to using under a) 2-hydroxypropylmethylcellulose having a 2-hydroxypropyl degree of substitution of 3 to 15 mol % and a methoxy degree of substitution of 26 to 31 mol % and a molecular weight of 80 000 g/mol to 110 000 g/mol.

Preference is given to using under a.) hydroxyethylmethylcellulose having a methoxy degree of substitution of 26 to 31 mol % and a hydroxyethoxy degree of substitution of 5 to 15 mol % and a molecular weight of 80 000 g/mol to 110 000 g/mol.

Preference is given to using under b) 2-hydroxypropylmethylcellulose having a 2-hydroxypropyl degree of substitution of 3 to 15 mol % and having a methoxy degree of substitution of 18 to 25 mol % and a molecular weight of 25 000 g/mol to 42 000 g/mol.

Preference is given to using under b) hydroxyethylmethylcellulose having a methoxy degree of substitution of 18 to 25 mol % and a hydroxyethoxy degree of substitution of 5 to 15 mol % and a molecular weight of 25 000 g/mol to 42 000 g/mol.

Particular preference is given to using a mixture comprising a) 2-hydroxypropylmethylcellulose having a 2-hydroxypropyl degree of substitution of 3 to 15 mol % and a methoxy degree of substitution of 26 to 31 mol % and a molecular weight of 80 000 g/mol to 110 000 g/mol and b) 2-hydroxypropylmethylcellulose having a 2-hydroxypropyl degree of substitution of 3 to 15 mol % and having a methoxy degree of substitution of 18 to 25 mol % and a molecular weight of 25 000 g/mol to 42 000 g/mol.

Very particular preference is given to using a mixture comprising a) 2-hydroxypropylmethylcellulose having a 2-hydroxypropyl degree of substitution of 3 to 8 mol % and a methoxy degree of substitution of 26 to 31 mol % and a molecular weight of 80 000 g/mol to 110 000 g/mol and b) 2-hydroxypropylmethylcellulose having a 2-hydroxypropyl degree of substitution of 6 to 13 mol % and having a methoxy degree of substitution of 18 to 25 mol % and a molecular weight of 25 000 g/mol to 42 000 g/mol.

The hydroxyalkylmethylcelluloses under a.) and b.) are known and can be prepared by generally known processes, for example by reaction of cellulose with an alkali metal hydroxide and subsequent reaction with an alkyl halide.

Hydroxyalkylmethylcelluloses are additionally commercially available. Especially preferably used as hydroxyalkylmethylcelluloses under a) are Methocel™ F4M (2-hydroxypropylmethylcellulose having a molecular weight of 95 000 g/mol) (DOW Chemical Company) (CAS No.: 9004-65-3), Walocel™ VPM 4937 (CAS No.: 9032-42-2) (hydroxyethylmethylcellulose having a molecular weight of 100 000 g/mol) and Tylose® E707002 (CAS No.: 9004-65-3) (2-hydroxypropylmethylcellulose having a molecular weight of 95 000 g/mol), or mixtures of these compounds.

Especially preferably used as hydroxyalkylmethylcelluloses under b) are Methocel™ K 100 (2-hydroxypropylmethylcellulose having a molecular weight of 33 500 g/mol) (CAS No.: 9004-65-3), and Metolose™ 90SH-100 (CAS No.: 9004-65-3) (2-hydroxypropylmethylcellulose having a molecular weight of 33 000 g/mol), or mixtures of these compounds.

The 2-hydroxypropylmethylcellulose used with preference under a), having a 2-hydroxypropyl degree of substitution of 3 to 15 mol % and a methoxy degree of substitution of 26 to 31 mol % and a molecular weight of 80 000 g/mol to 110 000 g/mol, preferably has a viscosity of 3000 to 9000 mPas.

The hydroxyethylmethylcellulose used with preference under a), having a methoxy degree of substitution of 26 to 31 mol % and a hydroxyethoxy degree of substitution of 5 to 15 mol % and a molecular weight of 80 000 to 110 000 g/mol, preferably has a viscosity of 3000 to 9000 mPas.

The 2-hydroxypropylmethylcellulose used with preference under b), having a 2-hydroxypropyl degree of substitution of 3 to 15 mol % and having a methoxy degree of substitution of 18 to 25 mol % and a molecular weight of 25 000 g/mol to 42 000 g/mol, preferably has a viscosity of 80 to 500 mPas.

Preferably under b) hydroxyethylmethylcellulose, having a methoxy degree of substitution of 18 to 25 mol % and a hydroxyethoxy degree of substitution of 7 to 10 mol % and a molecular weight of 25 000 to 42 000 g/mol, preferably has a viscosity of 80 to 500 mPas.

The 2-hydroxypropylmethylcellulose und hydroxyethylmethylcellulose used under a) and b) preferably have a thermal gelation temperature of >60° C.

The hydroxyalkylmethylcelluloses under a) and b) can be mixed with one another in any ratios. The ratio by weight of the hydroxyalkylmethylcelluloses a) and b) is preferably 3:1 to 1:1.

Preferably, the sum total concentration of the hydroxyalkylmethylcelluloses of a) and b) is 0.15-0.3% by weight, based on the aqueous phase.

The molar degree of substitution of the hydroxypropyl groups and the methoxy groups of the 2-hydroxypropylmethylcellulose is determined according to ASTM D-2363-72/USA.

The molar degree of substitution of the methoxy groups of the hydroxyethylmethylcellulose is determined according to ASTM D-1347-72/USA.

The molar degree of substitution of the hydroxyethoxy groups of the hydroxyethylmethylcellulose is determined according to ASTM D-2364-75/USA.

The molar degree of substitution can further be determined by ¹H NMR and ¹³C NMR spectroscopy.

The molecular weight of the hydroxyalkylmethylcellulose can be determined by the method from Journal of Polymer Science and Technology, 39(4), 293-298(1982).

The thermal gelation temperature can be determined in accordance with paragraph [0028] of EP-B1-1983004.

The viscosity of the hydroxyalkylmethylcelluloses can be determined by general methods known to those skilled in the art, preferably using a rotary viscometer at 25° C.

The 2-hydroxypropylmethylcellulose is preferably poly(O-2-hydroxypropyl,O-methyl)cellulose (CAS No.: 9004-65-3). The hydroxyethylmethylcellulose is preferably 2-hydroxyethylmethylcellulose (CAS No.: 9032-42-2).

The hydroxyalkylmethylcelluloses a) and b) may be added separately to the reaction in the process according to the invention. However, the hydroxyalkylmethylcelluloses may also be initially mixed and then added to the reaction mixture, or the hydroxyalkylmethylcelluloses are initially charged as a mixture and the buffer substances, monomers, crosslinkers, porogens and initiators added. This can be done in succession or as a mixture. Preferably, the hydroxyalkylmethylcelluloses a) and b) are first mixed and initially charged. The buffer substances are then preferably added. The mono- and multiethylenic compounds, the porogens and the initiators are then preferably added as a mixture to the hydroxyalkylmethylcelluloses.

In the process according to the invention, at least one monoethylenically unsaturated compound and at least one multiethylenically unsaturated compound are used.

However, it is also possible to use mixtures of two or more monoethylenically unsaturated compounds and mixtures of two or more multiethylenically unsaturated compounds.

Monoethylenically unsaturated compounds (monomers) for the purposes of the invention are compounds having one free-radically polymerizable C═C double bond per molecule. Preferred compounds of this kind include aromatic, monoethylenically unsaturated compounds such as vinyl and vinylidene derivatives of benzene and of naphthalene, such as preferably vinylnaphthalene, vinyltoluene, ethylstyrene, α-methylstyrene, chlorostyrenes, preferably styrene, and nonaromatic vinyl and vinylidene compounds, such as preferably acrylic acid, methacrylic acid, C₁-C₈-alkyl acrylates, C₁-C₈-alkyl methacrylates, acrylonitrile, methacrylonitrile, acrylamide, methacrylamide, vinyl chloride, vinylidene chloride and vinyl acetate. Preferably, the nonaromatic monoethylenically unsaturated compounds are used in minor amounts, preferably in amounts of 0.1% to 50% by weight, particularly preferably 0.5% to 20% by weight, based on aromatic monoethylenically unsaturated compounds. Preference is given to using exclusively aromatic monoethylenically unsaturated compounds.

The monoethylenically unsaturated compounds are preferably used in amounts of >50% by weight, based on the mixture of monoethylenically and multiethylenically unsaturated compounds, particularly preferably 80% by weight to 98% by weight, based on the mixture of monoethylenically and multiethylenically unsaturated compounds.

For the purposes of the present invention, the aromatic monoethylenically unsaturated compounds preferably used in the process according to the invention are styrene, vinyltoluene, ethylstyrene, α-methylstyrene, chlorostyrene, or chloromethylstyrene.

Especial preference is given to using styrene or mixtures of styrene with the aforementioned monomers, preferably with ethylstyrene.

Multiethylenic unsaturated compounds are compounds containing two or more, preferably two to four, free-radically polymerizable C═C double bonds per molecule. Preference is given to the aromatic multiethylenic unsaturated compounds divinylbenzene, divinyltoluene, trivinylbenzene, divinylnaphthalene, triallyl cyanurate, triallyl isocyanurate and trivinylnaphthalene. Preference is given to the nonaromatic multiethylenic unsaturated compounds diethylene glycol vinyl ether, octa-1,7-diene, hexa-1,5-diene, ethylene glycol dimethacrylate, triethylene glycol dimethacrylate, trimethylolpropane trimethacrylate, allyl methacrylate and N,N′-methylenebisacrylamide. The multiethylenic unsaturated compound used is particularly preferably divinylbenzene. Commercial divinylbenzene grades which, in addition to the isomers of divinylbenzene, also contain ethylvinylbenzene are sufficient for most applications.

For the purposes of the present invention, preferred multiethylenic unsaturated compounds in the process according to the invention are divinylbenzene, divinyltoluene, trivinylbenzene, divinylnaphthalene, triallyl cyanurate, triallyl isocyanurate or trivinylnaphthalene. Especial preference is given to using divinylbenzene.

The multiethylenically unsaturated compounds are preferably used in amounts of 1%-20% by weight, particularly preferably 2%-12% by weight, especially preferably 4%-10% by weight, based on the amount of monoethylenically unsaturated compounds. The type of multiethylenically unsaturated compounds (crosslinkers) is selected with regard to the later use of the polymer.

Macroporous polymers are formed by adding at least one porogen to the monoethylenically unsaturated compounds and multiethylenically unsaturated compounds in the polymerization in order to produce a macroporous structure in the polymer. Especially preferred porogens are hexane, octane, isooctane, isododecane, pentamethylheptane, methyl ethyl ketone, butanol or octanol and isomers thereof. Isododecane is very particularly preferably used as porogen. Especially suitable are organic substances that dissolve in the monoethylenically unsaturated compounds but are poor solvents or swellants for the polymer (precipitants for polymers), by way of example aliphatic hydrocarbons. Macroporous polymers preferably include polymers having a BET surface area of 20 to 100 m²/g. Porogens are preferably used in an amount of 25% by weight to 45% by weight based on the amount of the organic phase.

The polymers prepared by the process according to the invention may be prepared in heterodisperse or monodisperse form.

The suspension polymerization on which the process is based preferably leads to heterodisperse polymers.

Heterodisperse polymers are preferably prepared in the process according to the invention.

Macroporous polystyrene-divinylbenzene copolymers are particularly preferably prepared in the preparation process.

The scope of the invention encompasses all definitions of radicals, parameters and elucidations above and detailed hereinafter, in general terms or mentioned within preferred ranges, together with one another, i.e. including any combination between the respective ranges and preferred ranges.

In a preferred embodiment of the present invention, in the process according to the invention, microencapsulated monomer droplets are preferably used in the preparation of monodisperse polymers.

Materials useful for the microencapsulation of the monomer droplets are those known for use as complex coacervates, especially polyesters, natural and synthetic polyamides, polyurethanes or polyureas.

Preference is given to using gelatin as natural polyamide. This is employed especially as a coacervate and complex coacervate. For the purposes of the invention, gelatin-containing complex coacervates are especially understood to mean combinations of gelatin with synthetic polyelectrolytes. Suitable synthetic polyelectrolytes are copolymers incorporating units of, for example, maleic acid, acrylic acid, methacrylic acid, acrylamide and methacrylamide. Particular preference is given to using acrylic acid and acrylamide. Gelatin-containing capsules may be hardened with conventional hardeners, for example formaldehyde or glutardialdehyde. The encapsulation of monomer droplets with gelatin, gelatin-containing coacervates and gelatin-containing complex coacervates is described in detail in EP-A 0 046 535. The methods for encapsulation with synthetic polymers are known. Preference is given to interfacial condensation in which a reactive component (especially an isocyanate or an acid chloride) dissolved in the monomer droplet is reacted with a second reactive component (especially an amine) dissolved in the aqueous phase.

The heterodisperse or optionally microencapsulated, monodisperse monomer droplets contain preferably at least one initiator or mixtures of initiators (initiator combination) to trigger the polymerization. Initiators preferred for the process according to the invention are peroxy compounds, especially preferably dibenzoyl peroxide, dilauroyl peroxide, bis(p-chlorobenzoyl) peroxide, dicyclohexyl peroxydicarbonate, tert-butyl peroctoate, tert-butyl peroxy-2-ethylhexanoate, 2,5-bis(2-ethylhexanoylperoxy)-2,5-dimethylhexane or tert-amylperoxy-2-ethylhexane, and also azo compounds, such as 2,2′-azobis(isobutyronitrile) or 2,2′-azobis(2-methylisobutyronitrile). Particular preference is given to using dibenzoyl peroxide as initiator. Very particular preference is given to using tert-butyl peroxy-2-ethylhexanoate as initiator when an inhibitor is used.

The initiators are preferably employed in amounts of 0.05% to 2.5% by weight, particularly preferably 0.1% to 1.5% by weight, based on the monomer mixture.

The optionally monodisperse, microencapsulated monomer droplet may optionally also contain up to 30% by weight (based on the monomer) of crosslinked or uncrosslinked polymer. Preferred polymers derive from the aforementioned monomers, particularly preferably from styrene.

In the preparation of monodisperse or heterodisperse polymers in the process according to the invention, the aqueous phase in a further preferred embodiment may contain a dissolved polymerization inhibitor. Useful inhibitors in this case include both inorganic and organic substances. Preferred inorganic inhibitors are transition metal salts, such as copper(II) chloride, copper(II) sulfate, iron(III) chloride, iron(II) sulfate, manganese(II) chloride and inorganic nitrogen compounds, especially preferably hydroxylamine, hydrazine, sodium nitrite and potassium nitrite, salts of phosphorous acid such as sodium hydrogen phosphite and also sulfur-containing compounds such as sodium dithionite, sodium thiosulfate, sodium sulfite, sodium bisulfite, sodium thiocyanate and ammonium thiocyanate. Examples of organic inhibitors are phenolic compounds such as hydroquinone, hydroquinone monomethyl ether, resorcinol, catechol, tert-butylcatechol, pyrogallol and condensation products of phenols with aldehydes. Further preferred organic inhibitors are organic nitrogen-containing compounds. Especially preferred are hydroxylamine derivatives such as N,N-diethylhydroxylamine, N-isopropylhydroxylamine and sulfonated or carboxylated N-alkylhydroxylamine or N,N-dialkylhydroxylamine derivatives, hydrazine derivatives such as preferably N,N-hydrazinodiacetic acid, nitroso compounds such as preferably N-nitrosophenylhydroxylamine, N-nitrosophenylhydroxylamine ammonium salt or N-nitrosophenylhydroxylamine aluminum salt. The concentration of the inhibitor is preferably 5-1000 ppm (based on the aqueous phase), particularly preferably 10-500 ppm, very particularly preferably 10-250 ppm.

Preferably, at least one polymerization inhibitor is used in the process according to the invention. Sodium nitrite or resorcinol are particularly preferred as inhibitors.

In addition to the dispersant mixture used in the process according to the invention, further dispersants could also be added. Suitable additional dispersants are natural or synthetic water-soluble polymers, preferably gelatin, starch, polyvinyl alcohol, polyvinylpyrrolidone, polyacrylic acid, polymethacrylic acid or copolymers of (meth)acrylic acid and (meth)acrylic esters. Gelatin is especially preferred. The use amount of the additionally used dispersants is generally 0.05% to 10% by weight based on the dispersant mixture of a) and b) used according to the invention, preferably 0.05% to 5% by weight. It is preferable for no further dispersants to be added in addition to the dispersant mixture used in the process according to the invention.

The polymerization to give the heterodisperse or monodisperse polymer can, in an alternative preferred embodiment, be conducted in the presence of a buffer system. Preference is given to buffer systems which adjust the pH of the aqueous phase prior to the polymerization to a value between 14 and 6, preferably between 12 and 8. Under these conditions, dispersants having carboxylic acid groups are wholly or partly present as salts. This has a favorable effect on the action of the dispersants. Particularly well-suited buffer systems contain phosphate or borate salts. For the purposes of the invention, the terms “phosphate” and “borate” also encompass the condensation products of the ortho forms of corresponding acids and salts. The concentration of the phosphate or borate in the aqueous phase is preferably 0.5-500 mmol/l, particularly preferably 2.5-100 mmol/l.

The stirrer speed in the polymerization to give the monodisperse polymer is less critical and, in contrast to conventional polymerization, has no effect on the particle size. Low stirrer speeds sufficient to keep the suspended monomer droplets in suspension and to promote the removal of the heat of polymerization are employed. Various stirrer types can be used for this task. Particularly suitable stirrers are axial-action gate stirrers.

The volume ratio of monomer droplets to aqueous phase is preferably 1:0.75 to 1:20, particularly preferably 1:1 to 1:6. Irrespective of whether heterodisperse or monodisperse polymers are prepared.

The polymerization temperature to give the heterodisperse or monodisperse polymer is guided by the decomposition temperature of the initiator used. It is preferably between 50 to 180° C., particularly preferably between 55 and 130° C. The polymerization preferably lasts 0.5 to about 20 hours. It has proved useful to employ a temperature program in which the polymerization is commenced at low temperature, preferably 60° C., and the reaction temperature is raised as the polymerization conversion progresses. In this way, for example, the requirement for reliable running of the reaction and high polymerization conversion can be fulfilled very efficiently. After the polymerization, the polymer is isolated by conventional methods, for example by filtering or decanting, and optionally washed.

The preparation of the monodisperse polymers with the aid of the jetting principle or the seed-feed principle is known from the prior art and described, for example, in U.S. Pat. No. 4,444,961, EP-A 0 046 535, U.S. Pat. No. 4,419,245 or WO 93/12167.

The monodisperse polymers are preferably prepared with the aid of the jetting principle or the seed-feed principle.

Preferably, a macroporous, heterodisperse polymer is prepared in the process according to the invention.

The macroporous polymers are preferably used for the production of ion exchangers. The macroporous polymers can for instance be functionalized by known methods, such as sulfonation or chloromethylation or phthalamidation and reaction with alkylamines to give cation or anion exchangers and chelating resins.

The invention therefore likewise encompasses the use of a dispersant mixture comprising
a) at least one hydroxyalkylmethylcellulose having a molecular weight of 80 000 g/mol to 110 000 g/mol
and
b) at least one hydroxyalkylmethylcellulose having a molecular weight of 25 000 g/mol to 42 000 g/mol
for the preparation of a macroporous polymer.

The invention moreover relates to the use of the macroporous polymer, prepared using the dispersant mixture, for the production of ion exchangers.

### Methods

### Determination of the Polymeric Fines Fraction

For determination of the polymeric fines fraction, the reaction mixture comprising the polymer and the aqueous phase was screened through a screen having a mesh size of 100 μm. The filtrate from this filtration was in turn fed through a 20 μm screen. Thus, the polymeric fines fraction could be defined and quantified as a target grain fraction of 20 to 100 μm. Any fines fraction, as well as the aqueous phase remaining behind in the 20 μm screen, was evaporated and dried to constant mass. The polymeric fines fraction was then determined gravimetrically and calculated in percent based on the yield of the polymer.

### EXAMPLES

### Example 1

### According to the Invention

A glass reactor is initially charged with deionized water (869 mL) and 96.6 g of an aqueous 2 w % solution consisting of a.) 2-hydroxypropylmethylcellulose (HPMC), CAS: 9004-65-3, average viscosity, 2% in water @20° C.: 4550 mPas, methoxyl: 28.5 mol %, hydroxypropyl: 5.75 mol %) and a number-average molecular weight of 95 000 g/mol (type A) and b.) 2-hydroxypropylmethylcellulose (HPMC), CAS: 9004-65-3, average viscosity, 2% in water @20° C.: 100 mPas, methoxyl: 21.5 mol %, hydroxypropyl: 9.5 mol %) and a number-average molecular weight of 33 500 g/mol (type B) (ratio by weight 1:1). Disodium hydrogen phosphate decahydrate (4.69 g, 0.48 w %, based on aqueous phase) is additionally dissolved in this solution. The pH of the aqueous phase is then adjusted to a value of 11 by adding NaOH (1 M, 8-12 mL). To this aqueous phase is added a mixture of styrene (540.3 g, 80.4 w %), divinylbenzene (5.5 w %, 59.7 g), isododecane (351.5 g (32 w %)) and dibenzoyl peroxide (BPO) (4.69 g, (0.43 w %) (based on organic phase). A nitrogen stream of 20 l/h is introduced into the vessel. The mixture is initially heated to 73° C. at 190 rpm for 1 h, then held at this temperature for 7 h, then heated up to 95° C. over one hour and again held at this temperature for 2 h, and then cooled to room temperature. In this example, 559 g of polymer and a fines fraction of 3.9 g were isolated.

### Example 2

### According to the Invention

Example 1 is repeated, with 3.23 g of tert-butyl peroxy-2-ethylhexanoate (T21s) being used instead of the initiator benzoyl peroxide (BPO). In this example, 582 g of polymer and a fines fraction of 5.7 g were isolated.

### Example 3

### According to the Invention

Example 1 is repeated, with 3.23 g of tert-butyl peroxy-2-ethylhexanoate (T21s) being used instead of the initiator benzoyl peroxide (BPO). In addition, resorcinol (c=0.08 g/L in the aqueous phase) is added to the aqueous phase. In this example, 587 g of polymer and a fines fraction of 3.1 g were isolated.

### Example 4

### Not According to the Invention, the Use of a Low Molecular Weight Dispersant Component b.) was Dispensed with

A glass reactor is initially charged with deionized water (869 mL) and 96.6 g of an aqueous 2 w % solution of 2-hydroxypropylmethylcellulose (HPMC), CAS: 9004-65-3, average viscosity, 2% in water @20° C.: 4550 mPas, methoxyl: 28.5 mol %, hydroxypropyl: 5.75 mol %) and a number-average molecular weight of 95 000 g/mol (type A). Disodium hydrogen phosphate decahydrate (4.69 g, 0.48 w %, based on aqueous phase) is additionally dissolved in this solution. The pH of the aqueous phase is then adjusted to a value of 11 by adding NaOH (1 M, 8-12 mL). To this aqueous phase is added a mixture of styrene (540.3 g, 80.4 w %), divinylbenzene (5.5 w %, 59.7 g), isododecane (351.5 g (32 w %)) and dibenzoyl peroxide (BPO) (4.69 g, (0.43 w %) (based on organic phase). A nitrogen stream of 20 l/h is introduced into the vessel. The mixture is initially heated to 73° C. at 190 rpm for 1 h, then held at this temperature for 7 h, then heated up to 95° C. over one hour and again held at this temperature for 2 h, and then cooled to room temperature. In this example, 569 g of polymer and a fines fraction of 6.9 g were isolated.

### Example 5

### Not According to the Invention, the Use of a Low Molecular Weight Dispersant Component b.) was Dispensed with and the Initiator from Example 2 from EP-A-0964002 was Used

Example 4 is repeated, with 3.23 g of tert-butyl peroxy-2-ethylhexanoate (T21s) being used instead of the initiator benzoyl peroxide (BPO). In this example, 522 g of polymer and a fines fraction of 10.2 g were isolated.

### Example 6

### Not According to the Invention, the Use of a High Molecular Weight Dispersant Component a.) was Dispensed with

Example 4 is repeated, but instead of type A the same amount by weight of 2-hydroxypropylmethylcellulose (HPMC), CAS: 9004-65-3, average viscosity, 2% in water @20° C.: 100 mPas, methoxyl: 21.5 mol %, hydroxypropyl: 9.5 mol %) and a number-average molecular weight of 33 500 g/mol (type B) is used (ratio by weight of type A to type B: 1:1). In this example, 574 g of polymer and a fines fraction of 7.8 g were isolated.

### Example 7

### Not According to the Invention, the Use of a High Molecular Weight Dispersant Component a.) was Dispensed with and the Initiator from Example 2 from EP-A-0964002 was Used

Example 4 is repeated, but instead of type A the same amount by weight of 2-hydroxypropylmethylcellulose (HPMC), CAS: 9004-65-3, average viscosity, 2% in water @20° C.: 100 mPas, methoxyl: 21.5 mol %, hydroxypropyl: 9.5 mol %) and a number-average molecular weight of 33 500 g/mol (type B) is used. In addition, the initiator BPO is replaced by 3.23 g of tert-butyl peroxy-2-ethylhexanoate (T21s). In this example, 570 g of polymer and a fines fraction of 9.8 g were isolated.

### Example 8

### Not According to the Invention, Comparative Example 1 from EP-A-0964002, Resorcinol was Used as Inhibitor Instead of Sodium Nitrite

A glass reactor is initially charged with deionized water (869 mL) and 96.6 g of an aqueous 2 w % solution of methylcellulose (average viscosity 4000 mPas, Sigma Aldrich). Disodium hydrogen phosphate decahydrate (4.69 g, 0.48 w %, based on aqueous phase) and resorcinol (c=0.08 g/L in the aqueous phase) are additionally dissolved in this solution. The pH of the aqueous phase is then adjusted to a value of 11 by adding NaOH (1 M, 8-12 mL). To this aqueous phase is added a mixture of styrene (540.3 g, 80.4 w %), divinylbenzene (5.5 w %, 59.7 g), isododecane (351.5 g (32 w %)) and dibenzoyl peroxide (BPO) (4.69 g, (0.43 w %) (based on organic phase). A nitrogen stream of 20 l/h is introduced into the vessel. The mixture is initially heated to 73° C. at 190 rpm for 1 h, then held at this temperature for 7 h, then heated up to 95° C. over one hour and again held at this temperature for 2 h, and then cooled to room temperature. In this example, 569 g of polymer and a fines fraction of 7.2 g were isolated.

### Example 9

### According to the Invention

Example 1 is repeated, where, as dispersant, instead of a mixture of type A and type B, the same amount by weight is used of a mixture of hydroxyethylmethylcellulose having a methoxy degree of substitution of 28.5 mol % and a hydroxyethoxy degree of substitution of 10 mol % and a number-average molecular weight of 95 000 g/mol and 2-hydroxypropylmethylcellulose (HPMC), CAS: 9004-65-3, average viscosity, 2% in water @20° C.: 100 mPas, methoxyl: 21.5 mol %, hydroxypropyl: 9.5 mol %) and a number-average molecular weight of 33 500 g/mol (type B) in a weight ratio of 1:1. Resorcinol (0.08 g/l) is additionally added to the reaction mixture. In this example, 582 g of bead polymer and a fines fraction of 5.7 g were isolated.

TABLE 1

| | Cellulose | Cellulose | | Resorcinol | Fines fraction^{[i]} | Yield | Proportion of fines |
|---|---|---|---|---|---|---|---|
| Examples^{[h]} | ether 1 | ether 2 | Initiator^{[b], [c]} | [g] | [g] | [g] | fraction in yield |
| Example 1 | HPMC type A^{[f]} | HPMC type B^{[g]} | BPO | 0 | 3.8 | 559.1 | 0.68% |
| Example 2 | HPMC type A^{[f]} | HPMC type B^{[g]} | T21S | 0 | 5.7 | 582.18 | 0.98% |
| Example 3 | HPMC type A^{[f]} | HPMC type B^{[g]} | T21S | 0.8 | 3.1 | 587.13 | 0.53% |
| Example 4 | HPMC type A^{[f]} | — | BPO | 0 | 6.9 | 569.1 | 1.21% |
| Example 5 | HPMC type A^{[f]} | — | T21S | 0 | 10.2 | 521.68 | 1.96% |
| Example 6 | HPMC type B^{[g]} | — | BPO | 0 | 7.8 | 574.2 | 1.36% |
| Example 7 | HPMC type B^{[g]} | — | T21S | 0 | 9.80 | 570.73 | 1.72% |
| Example 8^{[d]} | Methylcellulose | — | T21S | 0.08 | 7.2 | 569.34 | 1.26% |
| Example 9 | Hydroxyethylmethylcellulose | HPMC type B^{[g]} | BPO | 0.08 | 4.1 | 561.0 | 0.73% |

[a] maximum yield 600 g,
^{[b]}benzoyl peroxide (BPO),
^{[c]}tert-butyl peroxy-2-ethylhexanoate (T21s),
^{[d]}comparative test with EP-A-0964002, instead of sodium nitrite, resorcinol was used as inhibitor,
[e] target grain fraction between 20-100 μm,
^{[f]}preferred hydroxypropylmethylcellulose (HPMC) described under a.),
^{[g]}preferred hydroxypropylmethylcellulose (HPMC) described under b.),
^{[h]}examples 1 to 3 are according to the invention, examples 4 to 8 are comparative tests.
^{[i]}fines fraction = polymeric fines fraction.
Examples 1 to 3 and 9 according to the invention demonstrate that by using a dispersant mixture comprising specific hydroxyalkylmethylcelluloses, the polymeric fines fraction can surprisingly be reduced in the preparation of a polymer.

1. A process for preparing a polymer, comprising reacting at least one monoethylenically unsaturated compound and at least one multiethylenically unsaturated compound in the presence of at least one initiator, water, a porogen and a dispersant mixture,
wherein the dispersant mixture comprises
a) at least one hydroxyalkylmethylcellulose having a number-average molecular weight of 80 000 g/mol to 110 000 g/mol and mixtures of these compounds and
b) at least one hydroxyalkylmethylcellulose having a number-average molecular weight of 25 000 g/mol to 42 000 g/mol and mixtures of these compounds.

2. The process for preparing a polymer as claimed in claim 1, wherein the at least one hydroxyalkylmethylcelluloses of a) and the at least one hydroxyalkylmethylcellulose of b) are selected from the group consisting of 2-hydroxypropylmethylcellulose, hydroxyethylmethylcellulose, and mixtures thereof.

3. The process for preparing a polymer as claimed in claim 1, wherein the at least one initiator is selected from the group consisting of dibenzoyl peroxide, dilauroyl peroxide, bis(p-chlorobenzoyl) peroxide, dicyclohexyl peroxydicarbonate, tert-butyl peroctoate, tert-butyl peroxy-2-ethylhexanoate, 2,5-bis(2-ethylhexanoylperoxy)-2,5-dimethylhexane, tert-amylperoxy-2-ethylhexane, 2,2′-azobis(isobutyronitrile), 2,2′-azobis(2-methylisobutyronitrile), and mixtures thereof.

4. The process for preparing a polymer as claimed in claim 1, wherein the at least one monoethylenically unsaturated compound is selected from the group consisting of styrene, vinyltoluene, ethylstyrene, α-methylstyrene, chlorostyrene, chloromethylstyrene, and mixtures of thereof.

5. The process for preparing a polymer as claimed in claim 1, wherein the at least one multiethylenically unsaturated compound is selected from the group consisting of divinylbenzene, divinyltoluene, trivinylbenzene, divinylnaphthalene, trivinylnaphthalene, and mixtures thereof.

6. The process for preparing a polymer as claimed in claim 1 5, wherein the at least one monoethylenically unsaturated compound is styrene and the at least one multiethylenically unsaturated compound is divinylbenzene.

7. The process for preparing a polymer as claimed in claim 1, further comprising adjusting pH of an aqueous phase prior to polymerization to a value between 12 and 8.

8. The process for preparing a polymer as claimed in claim 1, wherein the at least one hydroxyalkylmethylcellulose a) is a 2-hydroxypropylmethylcellulose having a 2-hydroxypropyl degree of substitution of 3 to 15 mol % and a methoxy degree of substitution of 26 to 31 mol %.

9. The process for preparing a polymer as claimed in claim 1, wherein the at least one hydroxyalkylmethylcellulose b) is a 2-hydroxypropylmethylcellulose having a hydroxypropyl degree of substitution of 3 to 15 mol % and a methoxy degree of substitution of 18 to 25 mol %.

10. The process for preparing a polymer as claimed in claim 1, wherein a ratio by weight of the at least one hydroxyalkylmethylcelluloses a) and the at least one hydroxyalkylmethylcellulose b) is 3:1 to 1:1.

11. The process for preparing a polymer as claimed in claim 1, wherein a sum total concentration of the at least one hydroxyalkylmethylcellulose a) and the at least one hydroxyalkylmethylcellulose b) is 0.15-0.3% by weight, based on the aqueous phase.

12. The process for preparing a polymer as claimed in claim 1, wherein an inhibitor is used that is selected from the group consisting of sodium dithionite, sodium thiosulfate, sodium sulfite, sodium bisulfite, sodium thiocyanate, ammonium thiocyanate, hydroquinone, hydroquinone monomethyl ether, resorcinol, catechol, tert-butylcatechol and pyrogallol.

13. The process for preparing a polymer as claimed in claim 1, wherein the porogen is selected from the group consisting of hexane, octane, isooctane, isododecane, methyl ethyl ketone, methyl isobutyl ketone, methyl isobutyl carbinol and octanol.

14. The process for preparing a polymer as claimed in claim 1, wherein polymerization is conducted at a temperature of 55 to 130° C.

15.-17. (canceled)
